(19) United States
(12) Patent Application Publication
(10) Pub. No.: US 2013/0277309 A1
(43) Pub. Date: Oct. 24, 2013

(54) MEMBRANE FILTRATION DEVICE AND OPERATING METHOD FOR MEMBRANE FILTRATION DEVICE

(71) Applicants: Shinichi Inoue, Ibaraki-shi (JP); Takahisa Konishi, Ibaraki-shi (JP); Kentarou Kobayashi, Ibaraki-shi (JP); Makoto Kobuke, Ibaraki-shi (JP)

(72) Inventors: Shinichi Inoue, Ibaraki-shi (JP); Takahisa Konishi, Ibaraki-shi (JP); Kentarou Kobayashi, Ibaraki-shi (JP); Makoto Kobuke, Ibaraki-shi (JP)

(73) Assignee: NITTO DENKO CORPORATION, Ibaraki-shi, Osaka (JP)

(21) Appl. No.: 13/978,425

(22) PCT Filed: Jan. 5, 2012
(86) PCT No.: PCT/JP2012/050102

§ 371 Date: Jul. 5, 2013

(30) Foreign Application Priority Data
Jan. 6, 2011 (JP) 2011-001372

(51) Int. Cl. B01D 65/00

(52) U.S. Cl. CPC B01D 65/00
USPC 210/650; 210/321.6; 210/321.66

(57) ABSTRACT

The purpose of the present invention is to provide a membrane filtration device able to supply electric power to a sensor under various conditions, including situations in which a plant is not operating. The membrane filtration device of the present invention comprises a membrane element for generating a permeate by filtering a liquid to be filtered through a filtration membrane, and includes a pressure-resistant container for containing the membrane element, a sensor for sensing the properties of the liquid flowing through the membrane filtration device, an electric-power-generating unit for generating electric power, and a primary battery. The sensor, the electric-power-generating unit, and the primary battery are provided inside the pressure-resistant container.

### TECHNICAL FIELD

The present invention relates to a membrane filtration device and an operating method for a membrane filtration device.

### BACKGROUND ART

Conventionally, a membrane filtration device is known that is configured in such a manner that a plurality of membrane elements that produce a permeate by filtering an object to be filtered with a filtration membrane (hereafter simply referred to as “membrane elements” are arranged on one straight line and the core tubes of adjacent membrane elements are connected with each other by a connection unit. The plurality of membrane elements connected in this manner are contained in an outer pipe formed, for example, of a resin and are treated as one membrane filtration device.

A membrane filtration device of this kind is generally used for obtaining purified permeated water (permeated liquid) by filtering raw water (raw liquid) such as waste water or sea water. In particular, in a large-scale plant or the like, numerous membrane filtration devices are held and supported by a rack referred to as a train, whereby management of processing characteristics (pressure, quality and amount of permeated water, and the like) is carried out train by train.

However, in the case of carrying out the management of the processing characteristics train by train as described above, the following problem is raised. That is, when there is a defect only in a membrane element or a connection unit in a part of the membrane filtration devices among the numerous membrane filtration devices held and supported by a train, it is difficult to identify the defective site, thereby imposing a great labor on the identification work.

Also, in a configuration in which numerous membrane filtration devices each of which is provided with a plurality of membrane elements are held and supported by a train as described above, the degree of contamination of the separation membrane and the load at the time the raw liquid is filtered by the separation membrane will differ in accordance with the position of each membrane filtration device within the train or the position of each membrane element within each membrane filtration device. For this reason, in exchanging membrane elements, new membrane elements and still usable membrane elements are suitably combined and contained within the outer pipe, thereby to optimize the arrangement and combination of the membrane elements so that eventually the optimal processing performances can be exhibited in the train as a whole. However, in a current situation, the optimization is carried out only on the basis of the period of use, so that it is not possible to say that the optimization is sufficiently carried out.

Further, determination of whether a maintenance such as cleaning or exchange of the membrane elements is to be executed or not is carried out on the basis of the processing characteristics for each train, so that there are cases in which the maintenance is not necessarily carried out suitably in some membrane elements depending on the position or period of use thereof. In other words, depending on the cases, some of the membrane elements may be in a state of being too late to carry out the maintenance, or there are cases in which the maintenance is carried out at a stage that is earlier than necessary.

In order to cope with such a problem, a method of disposing a sensor or the like in the outer pipe so as to sense the state of each membrane element in real time is disclosed (for example, see patent document 1). Patent document 1 discloses a configuration in which electric power is supplied to the sensor by using a wireless tag or a configuration in which electric power is supplied to the sensor from a battery. The aforesaid battery is chargeable, and the battery can also be charged using the wireless tag.

However, by the method disclosed in patent document 1, equipment for supplying electric power to the wireless tag from the outside must be disposed at a distance close to each outer pipe, thereby raising a problem of generating a lot of inconvenience in view of costs and space.

Thus, conventionally, a method of supplying electric power to the sensor by performing self power generation using the fluid pressure of the liquid flowing within the outer pipe is disclosed (for example, see patent document 2).

### PRIOR ART DOCUMENTS

### Patent Documents

Patent Document 1: JP 2009-508665 W
Patent Document 2: JP-A-2009-166034

### SUMMARY OF THE INVENTION

### Problems to be Solved by the Invention

However, by the method disclosed in patent document 2, self power generation cannot be carried out when the liquid is not flowing in the outer pipe, that is, under conditions in which a plant is not operating. For this reason, the method disclosed in patent document 2 leaves room for improvement in that, when the separation membrane is broken by some chemicals under conditions in which the plant is not operating due to planned stoppage or by chemical agent immersion cleaning or the like or when the membrane is peeled off by forward osmosis phenomenon because the operation is stopped under conditions in which water having a high salt concentration is present, the troubles cannot be found out until the electric power obtained by self power generation becomes capable of operating the sensor.

The present invention has been made in view of the aforementioned problems, and an object thereof is to provide a membrane filtration device capable of supplying electric power to the sensor under various conditions including situations in which the plant is not operating, as well as a method of operating the membrane filtration device.

### Means for Solving the Problems

In order to achieve the aforementioned object, the present invention provides the following.

(1) A membrane filtration device provided with a membrane element that produces a permeate by filtering an object to be filtered with a filtration membrane, comprising:

a pressure-resistant container that contains the membrane element;

a sensor that senses the properties of the liquid flowing through the membrane filtration device;

a power-generating unit that generates electric power; and

a primary battery,

wherein the sensor, the power-generating unit, and the primary battery are provided in the inside of the pressure-resistant container.

According to the invention of (1), since the primary battery is provided, electric power can be supplied to the sensor even under conditions in which the self power generation cannot be carried out. As a result of this, the state of each membrane element can be sensed in real time even under various conditions including situations in which the plant is not operating. In particular, at the time of starting the device, it is often difficult to drive the sensor with the electric power obtained only by the self power generation. However, in the invention of (1), since the primary battery is provided, the sensor can be driven at and after the time of starting the device. As a result of this, inconvenience at an initial stage of starting when troubles are liable to occur can be found out early. Also, at the time of continuous operation when an amount of electric power supplied by self power generation is sufficient, the sensor can be driven using the electric power generated by the self power generation instead of the primary battery, so that the amount of electric power consumption of the primary battery can be reduced. In this manner, according to the invention of (1), the frequency of exchanging the primary batteries can be reduced, and also the state of each membrane element can be sensed in real time even under various conditions including situations in which the plant is not operating.

Further, the present invention provides the following.

(2) The membrane filtration device according to (1) described above, including a mounting member that can be attached to and detached from the membrane element, wherein the sensor, the power-generating unit, and the primary battery are provided on the mounting member.

According to the invention of (2), the sensor, the power-generating unit, and the primary battery are provided on the mounting member that can be attached to and detached from the membrane element, so that the sensor can be used again by re-attaching the mounting member to a new spiral-type membrane element even when the membrane elements are to be exchanged.

Further, the present invention provides the following.

(3) The membrane filtration device according to (1) or (2) described above, wherein a secondary battery that stores the electric power obtained in the power generating unit is provided in the pressure-resistant container.

According to the invention of (3), the secondary battery that stores the electric power obtained in the power generating unit is provided. Therefore, even when the output of the self power generation decreases by some causes, the sensor can be driven using the electric power stored in the secondary battery.

Further, the present invention provides the following.

(4) The membrane filtration device according to (1) or (2) described above, wherein the power-generating unit includes a rotary body that rotates by a fluid pressure of the liquid flowing within the membrane filtration device, and electric power is generated on the basis of the rotation of the rotary body.

According to the invention of (4), the rotary body rotates by the fluid pressure of the liquid when the liquid is flowing within the membrane filtration device, and the electric power is generated in the power-generating unit on the basis of the rotation thereof. Therefore, power generation can be carried out efficiently using the rotary body.

Further, the present invention provides the following.

(5) A method of operating the membrane filtration device according to (1) described above, comprising:

a stage (a) of driving the sensor with an electric power of the primary battery; and

a stage (b) of switching the driving of the sensor with the electric power of the primary battery to driving with the electric power obtained by the power-generating unit when the electric power obtained by the power-generating unit assumes a first specific value or above.

According to the invention of (5), the sensor is driven by the electric power of the primary battery, so that the electric power can be supplied to the sensor even under conditions in which the self power generation cannot be carried out. As a result of this, the state of each membrane element can be sensed in real time even under various conditions including situations in which the plant is not operating. In particular, at the time of starting the device, it is often difficult to drive the sensor with the electric power obtained only by the self power generation; however, according to the invention of (5), the sensor is driven by the electric power of the primary battery, so that the sensor can be driven at and after the time of starting the device. As a result of this, inconvenience at an initial stage of starting when troubles are liable to occur can be found out early. Also, the driving of the sensor with the electric power of the primary battery is switched to driving with the electric power obtained by the power-generating unit when the electric power obtained by the power-generating unit assumes a first specific value (for example, a value corresponding to the electric power needed for driving the sensor) or above. Therefore, at the time of continuous operation when an amount of electric power supplied by the self power generation is sufficient, the sensor can be driven using the electric power generated by the self power generation instead of the primary battery, so that the amount of electric power consumption of the primary battery can be reduced. In this manner, according to the invention of (5), the frequency of exchanging the primary batteries can be reduced, and also the state of each membrane element can be sensed in real time even under various conditions including situations in which the plant is not operating.

Further, the present invention provides the following.

(6) A method of operating the membrane filtration device according to (3) described above, comprising:

a stage (a) of driving the sensor with an electric power of the primary battery; and

a stage (c) of switching the driving of the sensor with the electric power of the primary battery to driving with the electric power of the secondary battery when a voltage of the secondary battery assumes a second specific value or above.

According to the invention of (6), the sensor is driven by the electric power of the primary battery, so that the electric power can be supplied to the sensor even under conditions in which the self power generation cannot be carried out. As a result of this, the state of each membrane element can be sensed in real time even under various conditions including situations in which the plant is not operating. In particular, at the time of starting the device, it is often difficult to drive the sensor with the electric power obtained only by the self power generation; however, according to the invention of (6), the sensor is driven by the electric power of the primary battery, so that the sensor can be driven at and after the time of starting the device. As a result of this, inconvenience at an initial stage of starting when troubles are liable to occur can be found out early. Also, the driving of the sensor with the electric power of the primary battery is switched to driving with the electric power of the secondary battery when the voltage of the secondary battery assumes a second specific value or above. Therefore, at the time of continuous operation when an amount of electric power supplied by the self power generation is sufficient, the sensor can be driven using the electric power of the secondary battery stored by the self power generation instead of the primary battery, so that the amount of electric power consumption of the primary battery can be reduced. In this manner, according to the invention of (6), the frequency of exchanging the primary batteries can be reduced, and also the state of each membrane element can be sensed in real time even under various conditions including situations in which the plant is not operating. Also, the driving of the sensor with the electric power of the primary battery is switched to driving with the electric power of the secondary battery when a voltage of the secondary battery assumes a second specific value or above, so that the sensor can be stably driven by the electric power stored in the secondary battery.

### Effect of the Invention

According to the present invention, a membrane filtration device capable of supplying electric power to a sensor under various conditions including situations in which a plant is not operating, as well as a method of operating the membrane filtration device can be provided.

### BRIEF DESCRIPTION OF THE DRAWINGS

FIG. 1 is a schematic cross-sectional model view illustrating a membrane filtration device according to one embodiment of the present invention.

FIG. 2 is a perspective view illustrating an internal configuration of a spiral-type membrane element shown in FIG. 1.

FIG. 3A is a schematic perspective view illustrating a configuration of an element connection member shown in FIG. 1.

FIG. 3B is a front view of the element connection member shown in FIG. 3A.

FIG. 3C is a partial enlarged perspective view of the element connection member shown in FIG. 3A.

FIG. 4 is a block diagram illustrating an electrical configuration of the membrane filtration device shown in FIG. 1.

FIG. 5 is a flowchart showing a switching process executed in the membrane filtration device shown in FIG. 1.

FIG. 6 is a flowchart showing a switching process executed in a membrane filtration device according to another embodiment.

FIG. 7 is a schematic perspective view illustrating a configuration of an element connection member according to another embodiment.

FIG. 8 is a front view illustrating a configuration of an element connection member according to another embodiment.

### MODE FOR CARRYING OUT THE INVENTION

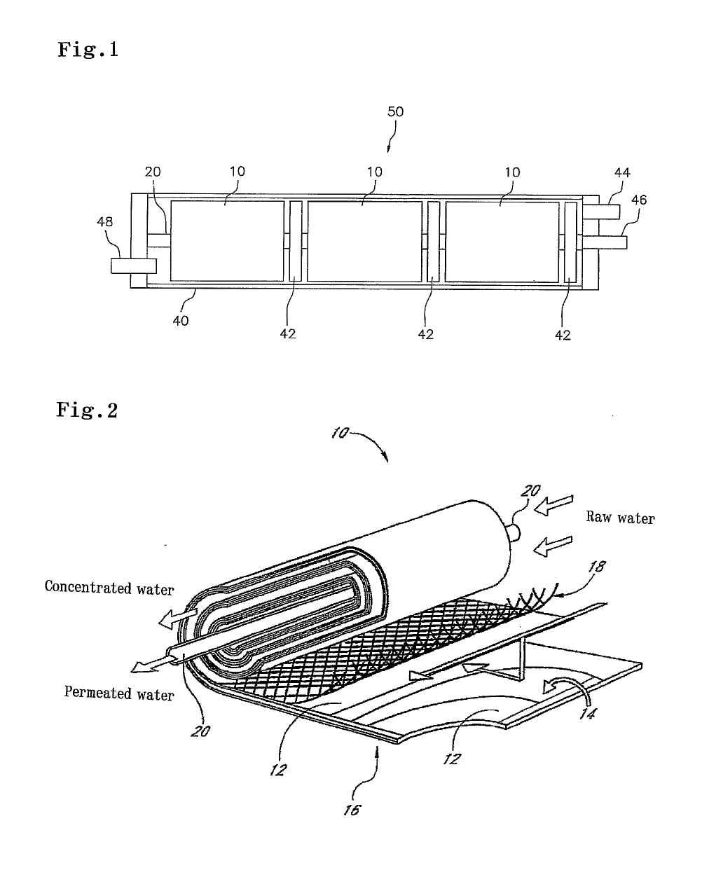

FIG. 1 is a schematic cross-sectional model view illustrating a membrane filtration device according to one embodiment of the present invention. Also, FIG. 2 is a perspective view illustrating an internal configuration of a spiral-type membrane element shown in FIG. 1. The membrane filtration device 50 is constructed by arranging a plurality of spiral-type membrane elements 10 (hereafter simply referred to as “membrane elements 10” on one straight line in a pressure-resistant container 40.

The pressure-resistant container 40 is a tubular body made of resin and is formed, for example, of FRP (Fiberglass Reinforced Plastics). At one end of the pressure-resistant container 40, a raw water flow inlet 48 through which raw water (raw liquid) such as waste water or sea water flows in is formed. By filtration of the raw water that flows in through the raw water flow inlet 48 with a plurality of membrane elements 10, purified permeated water (permeated liquid) and concentrated water (concentrated liquid) which is the raw water after filtration are obtained. At the other end of the pressure-resistant container 40, a permeated water flow outlet 46 through which the permeated water flows out and a concentrated water flow outlet 44 through which the concentrated water flows out are formed.

Referring to FIG. 2, the membrane element 10 is an RO (Reverse Osmosis: reverse osmosis) membrane element that is formed by winding a filtration membrane 12, a feed side passage 18, and a permeate side passage material 14 in a laminated state around a core tube 20 in a spiral form.

More specifically, on both surfaces of the permeate side passage material 14 composed of a net-shaped member made of resin and having a rectangular shape, a filtration membrane 12 composed of the same rectangular shape is superposed, and the three sides thereof are bonded, whereby a bag-shaped membrane member 16 having an opening at one side is formed. Then, the opening of this membrane member 16 is attached to an outer circumferential surface of a core tube 20 and is wound around the core tube 20 together with the feed side passage 18 composed of a net-shaped member made of resin, whereby the aforesaid membrane element 10 is formed. The aforesaid filtration membrane 12 is formed, for example, by successive lamination of a porous support and a skin layer (dense layer) on a non-woven cloth layer.

When raw water is supplied through one end of the membrane element 10 formed as described above, the raw water passes within the membrane element 10 via a raw water flow path formed of the feed side passage 18 functioning as a raw water spacer. During that time, the raw water is filtered by the separation membrane 12, and the permeated water that has been filtered from the raw water penetrates into a permeated water flow path formed of the permeate side passage material 14 functioning as a permeated water spacer.

Thereafter, the permeated water that has penetrated into the permeated water flow path passes through the permeated water flow path to flow to the core tube 20 side, and is guided into the core tube 20 through a plurality of water-passing holes (not illustrated) formed on the outer circumferential surface of the core tube 20. This allows that the permeated water flows out via the core tube 20 from the other end of the membrane element 10, and the concentrated water flows out via the raw water flow path formed of the feed side passage 18.

Referring to FIG. 1, a plurality of membrane elements 10 that are contained within the pressure-resistant container 40 are formed in such a manner that the core tubes 20 of adjacent membrane elements 10 are connected with each other by an element connection member 42. Therefore, the raw water that has flowed in through the raw water flow inlet 48 flows into the raw water flow path successively from the membrane element 10 on the raw water flow inlet 48 side, and the permeated water that has been filtered from the raw water by each membrane element 10 flows out through the permeated water flow outlet 46 via one core tube 20 connected by the element connection members 42. On the other hand, the concentrated water that has been concentrated by filtration of the permeated water by passing through the raw water flow path of each membrane element 10 flows out through the concentrated water flow outlet 44. The element connection member 42 may be made, for example, of a resin such as ABS, vinyl chloride, or polyphenylene ether, or a metal such as stainless steel; however, in view of facility in processing at the time of mounting the sensor or easiness of attachment and detachment, the element connection member 42 is preferably made of resin. The element connection member 42 corresponds to the mounting member of the present invention.

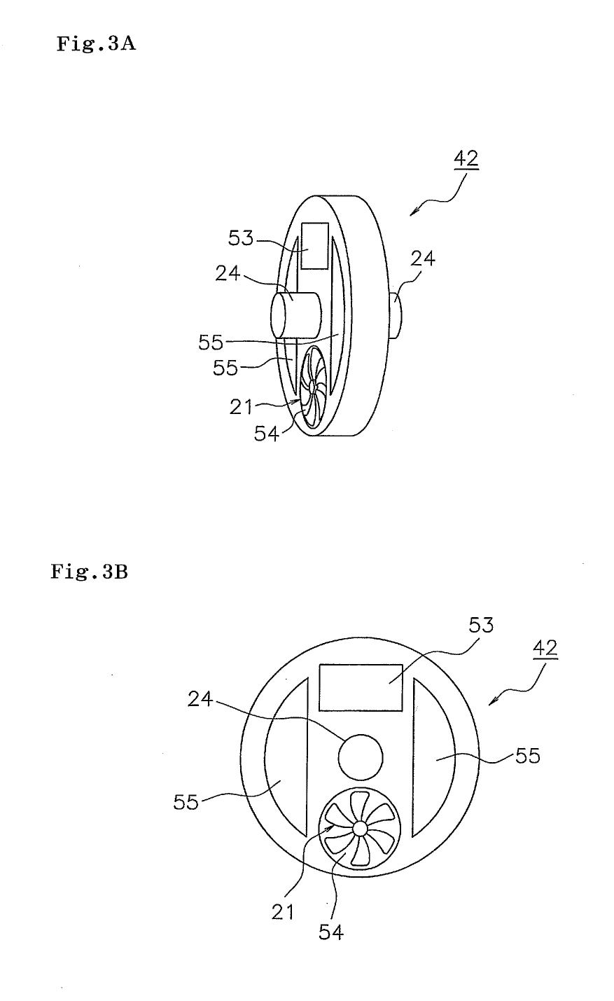

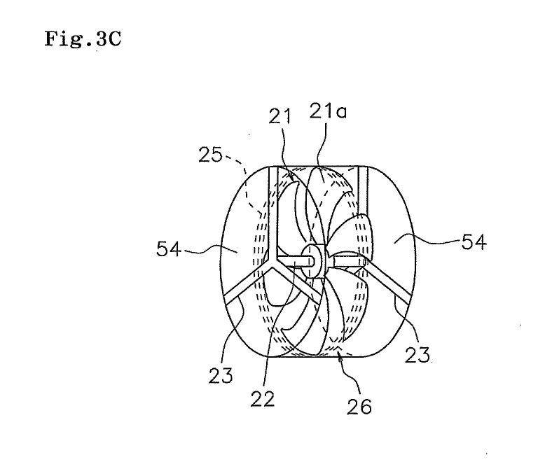

FIG. 3A is a schematic perspective view illustrating a construction of the element connection member, and FIG. 3B is a front view thereof. Also, FIG. 3C is a partial enlarged perspective view of the element connection member shown in FIG. 3A. The element connection member 42 has a shape such that the outer circumferential surface thereof corresponds to the outer circumferential surface of the membrane element 10, and the outer circumferential surface of the element connection member 42 faces close to the inner circumferential surface of the pressure-resistant container 40.

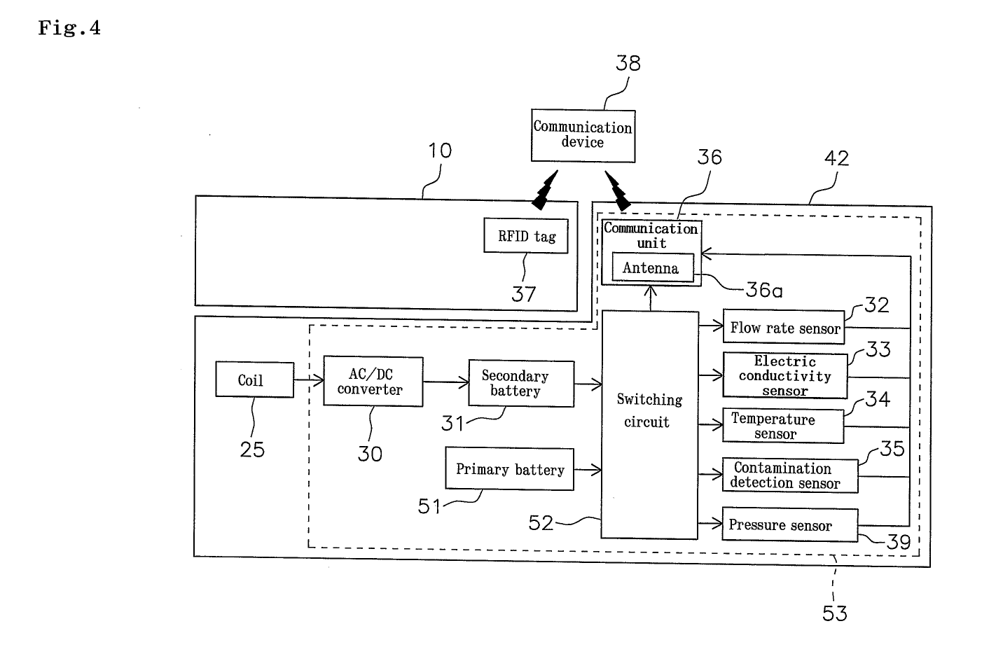

A substrate 53 and sensors (flow rate sensor 32, electric conductivity sensor 33, temperature sensor 34 and contamination detection sensor 35, pressure sensor 39) (See FIG. 4) are mounted on the element connection member 42, on the element connection member 42. In view of preventing damages under a high-pressure and in-water environment, the substrate 53 and the sensors preferably have a protection structure. The protection structure may be a structure of enclosing into a pressure-resistant container made of metal or a structure of surrounding and burying with resin; however, the structure of surrounding and burying with resin is preferable because the structure can be made to have a pressure resistance property with a small volume. Examples of the resin used in the aforesaid protection structure include polystyrene (PS), acrylonitrile-butadiene-styrene copolymer synthetic resin (ABS), polymethyl methacrylate (PMMA), polycarbonate (PC), vinyl chloride resin (PVC), nylon 6 (PA), polyacetal (POM), polyethylene terephthalate (PET), polybutylene terephthalate (PBT), polyphenylene oxide (PPO), polysulfone (PSF), polyphenylene sulfide (PPS), polyallylsulfone (PAS), polyarylate (PAR), polyphenylene ether (PPE), polyethersulfone (PES), polyether ether ketone (PEEK), polyimide (PI), epoxy resin, urethane resin, and others. Further, from the viewpoint of improving the strength, a glass fiber, a carbon fiber, and a filler may be added to these resins.

Also, a water-passing pipe 24 is formed at the center, as viewed in the front view, of the element connection member 42, and an opening 54 having a circular shape, as viewed in the front view, is provided outside of the water-passing pipe 24 (on the side lower than the water-passing pipe 24 in FIG. 3B). Also, in the element connection member 42, an opening 55 having a crescent shape is provided, separately from the opening 54, on the right and left sides of the water-passing pipe 24 as viewed in the front view. The water-passing pipe 24 is capable of connecting the core tubes 20 of the membrane elements 10 with each other and is capable of passing the permeated water in the inside thereof. The opening 54 and the opening 55 are capable of passing the concentrated water that flows within the element connection member 42.

In the opening 54, a blade wheel 21 functioning as a rotary body that rotates by a fluid pressure of the concentrated water that flows within the element connection member 42 is provided. However, the aforesaid rotary body is not limited to the blade wheel 21, so that those having various shapes can be adopted.

In the opening 54, a main shaft 22 is disposed along the central axial line thereof, and the two ends of the main shaft 22 are held by a holding section 23 at the two ends of the interconnector 42. The holding section 23 is made of a plurality of rod members that extend radially relative to the central axial line of the interconnector 42, and the concentrated water passes via the space between these rod members.

The blade wheel 21 has a plurality of blades 21a whose tip ends each extend to a position close to the inner circumferential surface of the opening 54. Therefore, the concentrated water that has flowed into the element connection member 42 via the opening 54 passes within the element connection member 42 while being in contact with the blades 21a of the blade wheel 21 and flows out through the other end of the element connection member 42, whereby the blade wheel 21 rotates by the fluid pressure of the concentrated water that acts on the blades 21a.

A coil 25 is formed by winding a metal wire around the blade wheel 21. Also, a magnet (not illustrated) is mounted on the tip end of each blade 21a of the blade wheel 21. Such a construction allows that, when the blade wheel 21 rotates, the magnetic field formed by the aforesaid magnet around the coil 25 changes, whereby an induction current flows through the coil 25 by what is known as electromagnetic induction. In other words, the magnet mounted on the blade wheel 21 and the coil 25 constitute a power-generating unit 26 that generates electric power on the basis of the rotation of the blade wheel 21.

According to such a construction, electric power can be generated in the power-generating unit 26 on the basis of the rotation of the blade wheel 21 when the concentrated water is flowing within the element connection member 42. Therefore, power generation can be carried out efficiently by using the blade wheel 21.

FIG. 4 is a block diagram illustrating an electrical construction of the membrane filtration device 50 shown in FIG. 1. This membrane filtration device 50 includes an AC/DC converter 30, a secondary battery 31, a primary battery 51, a switching circuit 52, a flow rate sensor 32, an electric conductivity sensor 33, a temperature sensor 34, a contamination detection sensor 35, a pressure sensor 39, a communication unit 36, an RFID tag 37, and others in addition to the aforementioned coil 25.

Among the units provided in the membrane filtration device 50, the AC/DC converter 30, the secondary battery 31, the primary battery 51, the switching circuit 52, the flow rate sensor 32, the electric conductivity sensor 33, the temperature sensor 34, the contamination detection sensor 35, the pressure sensor 39, and the communication unit 36 are mounted on a substrate 53 attached to the membrane filtration device 50. In addition to these, an IC chip that controls power source supply and wireless communication and a quartz oscillator serving as a timing device may be mounted on the substrate 53. The membrane filtration device 50 can sense the properties of the permeated water that passes within the element connection member 42 by using the flow rate sensor 32, the electric conductivity sensor 33, the temperature sensor 34, and the contamination detection sensor 35 mounted on the substrate 53. According to such a construction, the terminals of the sensors are less liable to be contaminated, and the stability of sensing precision can be maintained. Also, since there is no need to sense the water quality that is less liable to be stabilized such as in the raw water, the sensitivity of the sensors can be limited to needed ranges. Also, since the water quality for each membrane element 10 immediately after being permeated through the membrane can be sensed, abnormality and performance of the membrane for each membrane element 10 can be confirmed. Also, even when the abnormality occurs only in the sensors, there is no need to exchange the whole membrane element 10 that is expensive, so that the exchange can be carried out inexpensively and easily. On the other hand, the RFID tag 37 is mounted on a membrane member 16 that forms the outer circumferential surface of the membrane element 10. However, the present invention is not limited to such a construction, so that it is possible to adopt a construction in which the AC/DC converter 30, the secondary battery 31, the primary battery 51, the switching circuit 52, the communication unit 36, and the like are mounted on other parts in the membrane filtration device 50 other than the element connection member 42, for example, on the core tube 20 of the membrane element 10 or on the pressure-resistant container 40 or the like.

Also, it is possible to adopt a construction in which at least one of the various sensors such as the flow rate sensor 32, the electric conductivity sensor 33, the temperature sensor 34, the contamination detection sensor 35, and the pressure sensor 39, or the power-generating unit 26 is mounted on other parts in the membrane filtration device 50 other than the element connection member 42, for example, on the core tube 20 of the membrane element 10 or on the pressure-resistant container 40 or the like. Furthermore, it is possible to adopt a construction in which the RFID tag 37 is mounted on another part in the membrane element 10 other than the membrane member 16, for example, on the core tube 20 or the like.

The induction current generated in the coil 25 is converted from an alternating current (AC) to a direct current (DC) by the AC/DC converter 30 and supplied to the secondary battery 31. The electric power stored in the secondary battery 31 is supplied not only to various sensors such as the flow rate sensor 32, the electric conductivity sensor 33, the temperature sensor 34, and the contamination detection sensor 35 provided in the membrane filtration device 50, but also to other electric components such as the communication unit 36. The secondary battery is a device that stores electric charge, and may be, for example, a battery (storage battery) or a capacitor. The aforementioned battery may be, for example, a lithium ion battery, a lithium ion polymer battery, a nickel•hydrogen battery, a nickel•cadmium battery, a nickel•iron battery, a nickel•zinc battery, a silver oxide•zinc storage battery, or the like. The aforementioned capacitor may be, for example, a ceramic capacitor, a plastic film capacitor, a mica capacitor, an electric field capacitor, a tantalum capacitor, an electric double-layer capacitor, or the like. Among these, a capacitor that does not involve chemical reaction is preferable and, among the capacitors, an electric double-layer capacitor having a large electrostatic capacitance is more preferable.

The switching circuit 52 has a function of switching the source of supplying the electric power to the primary battery 51 or the secondary battery 31 in accordance with the voltage of the secondary battery 31. The primary battery may be, for example, a manganese battery, an alkaline battery, a silver oxide battery, a lithium battery, or the like, and a commercially available one can be used. Among these, an alkaline battery is preferable from the viewpoint of costs, lifetime, and stability. The shape of the primary battery may be, for example, a tubular shape, a button shape, a coin shape, a flat shape, a prismatic shape, or the like. Because the primary battery is placed in the inside of the pressure-resistant container 40 (for example, the element connection member 42), the primary battery preferably has a small volume. Also, from the viewpoint of stability of the voltage supplied to various sensors, the primary battery preferably has a tubular shape. The needed voltage may differ depending on the construction of the membrane filtration device; however, the voltage is typically 1.2 V or higher and, from the viewpoint of stable operation, the voltage is preferably 1.8 V or higher. Therefore, a plurality of primary batteries may be connected in series for use in accordance with the needs. Also, because an amount of electric power more than necessary may lead to leakage of electricity or the like, it is generally preferable that the voltage is 3.5 V or lower, though depending on the construction of the membrane filtration device. The aforesaid other electric components may include, for example, a position sensing unit such as a GPS (Global Positioning System). Here, it may be constructed in such a manner that the electric power stored in the secondary battery 31 is output to the outside from an electric power outputting unit constructed with an electrode or the like.

The flow rate sensor 32, the electric conductivity sensor 33, the temperature sensor 34, and the contamination detection sensor 35 are each a sensor that senses the property of the permeated water that flows within the element connection member 42, and are provided in the inside of the element connection member 42.

The flow rate sensor 32 is a sensor that senses the flow rate of the permeated water that flows within the water-passing pipe 24 and can be constructed, for example, in such a manner that a blade wheel (for example, a blade wheel similar to the blade wheel 21 provided in the opening 54) is provided in the water-passing pipe 24 and, by rotation of the blade wheel by the fluid pressure of the permeated water, the flow rate is sensed on the basis of the rotation number thereof.

The electric conductivity sensor 33 is a sensor that senses the electric conductivity of the permeated water that flows within the water-passing pipe 24. The temperature sensor 34 is a sensor that senses the temperature of the permeated water that flows within the water-passing pipe 24, and can be constructed, for example, with a thermocouple or the like. The contamination detection sensor 35 is a sensor that detects the contamination state of the permeated water that flows within the water-passing pipe 24. The pressure sensor 39 is a sensor that is disposed outside of the element connection member 42 and senses the pressure of the raw water that flows outside the element connection member 42. The pressure sensor 39 can be constructed, for example, with a piezoelectric element, a strain gauge, or the like. However, the sensors mounted on the mounting member such as the element connection member 42 are not limited to the above sensors, so that any of the sensors known in the art such as physical sensors, chemical sensors, and smart sensors (sensors equipped with an information processing function) can be used in accordance with the characteristics thereof as long as they are the sensors that sense the property of the liquid flowing within the membrane filtration device 50. Here, the property of the liquid that is sensed by the sensors mounted on the mounting member such as the element connection member 42 may be, for example, a flow rate, a pressure, an electric conductivity, a temperature, a state of contamination (ion concentration or the like), or the like.

The communication unit 36 has an antenna 36a and constitutes a wireless transmission unit that wirelessly transmits a detection signal from various sensors such as the flow rate sensor 32, the electric conductivity sensor 33, the temperature sensor 34, the contamination detection sensor 35, and the pressure sensor 39 to the communication device 38. The antenna 36a of the communication unit 36 can be formed, for example, by winding a metal wire around the element connection member 42.

The RFID tag 37 is a wireless tag that includes a storage medium capable of storing data and can transmit and receive data to and from a communication device 38 by non-contact communication using an electric wave. This RFID tag 37 may be an active type having an electricity storage unit or may be a passive type that does not have an electricity storage unit and obtains electric power by generating electromagnetic induction on the basis of the electric wave from the communication device 38.

The RFID tag 37 can store data related to the membrane element 10 on which the RFID tag 37 is mounted. The data stored in this RFID tag 37 may be, for example, position information of the membrane element 10, history of manufacturing the membrane element 10, performance data of the membrane element 10, road map data of the membrane element 10, or the like.

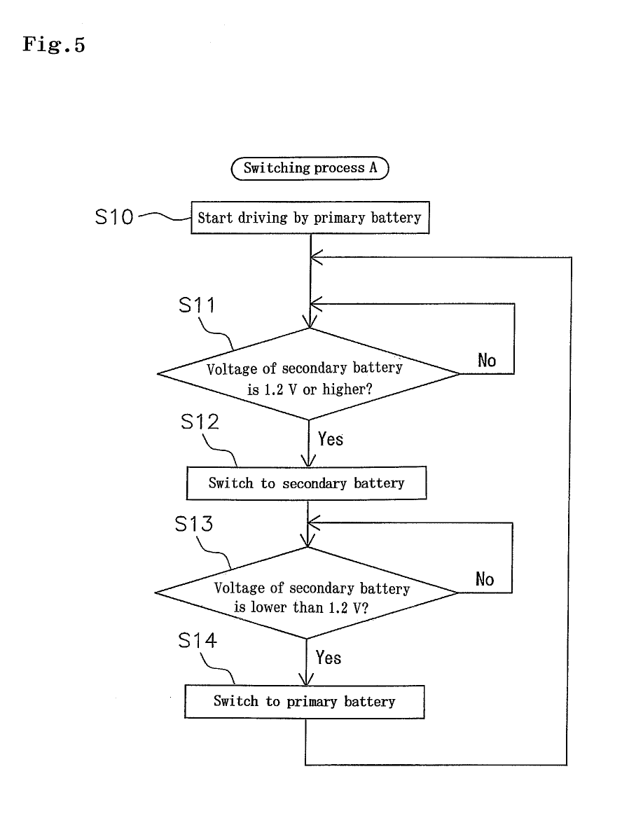

Next, a switching process executed in the membrane filtration device will be described. FIG. 5 is a flowchart showing a switching process A that is executed in the membrane filtration device. First, when the power source is turned on in the membrane filtration device 50, the various sensors, the communication unit 36, and others are driven by the electric power of the primary battery 51 (step S10).

Next, the switching circuit 52 determines whether the voltage of the secondary battery 31 is above or equal to 1.2 V (above or equal to the second specific value) or not (step S11). When it is determined in the step S11 that the voltage of the secondary battery 31 is not above or equal to 1.2 V, the process is returned to the step S11. On the other hand, when it is determined that the voltage of the secondary battery 31 is above or equal to 1.2 V, the switching circuit 52 switches the driving of the various sensors, the communication unit 36, and others with the electric power of the primary battery 51 to driving with the electric power of the secondary battery 31 (step S12).

After the process of the step S12, the switching circuit 52 determines whether the voltage of the secondary battery 31 is less than 1.2 V or not (step S13). When it is determined in the step S13 that the voltage of the secondary battery 31 is not less than 1.2 V, the process is returned to the step S13. On the other hand, when it is determined that the voltage of the secondary battery 31 is less than 1.2 V, the switching circuit 52 switches the driving of the various sensors, the communication unit 36, and others with the electric power of the secondary battery 31 to driving with the electric power of the primary battery 51 (step S14). Thereafter, the process is returned to the step S11.

In this manner, according to the membrane filtration device 50, various sensors, the communication unit 36, and others are driven by the electric power of the primary battery 51, so that the electric power can be supplied to the sensors and others even under conditions in which the self power generation cannot be carried out. As a result of this, the state of each membrane element 10 can be sensed in real time even under various conditions including situations in which the plant is not operating. In particular, at the time of starting the device, it is often difficult to drive the sensors and others with the electric power obtained only by the self power generation; however, according to the membrane filtration device 50, the sensors and others are driven by the electric power of the primary battery 51, so that the sensors and others can be driven at and after the time of starting the device. As a result of this, inconvenience at an initial stage of starting when troubles are liable to occur can be found out early. Also, the driving of the sensors and others with the electric power of the primary battery 51 is switched to driving with the electric power of the secondary battery 31 when the voltage of the secondary battery 31 assumes a second specific value or above (1.2 V or above in the present embodiment). Therefore, at the time of continuous operation when an amount of electric power supplied by the self power generation is sufficient, the sensors and others can be driven using the electric power of the secondary battery 31 stored by the self power generation instead of the primary battery 51, so that the amount of electric power consumption of the primary battery can be reduced. In this manner, according to the membrane filtration device 50, the frequency of exchanging the primary batteries 51 can be reduced, and also the state of each membrane element 10 can be sensed in real time even under various conditions including situations in which the plant is not operating. Also, the driving of the sensors and others with the electric power of the primary battery 51 is switched to driving with the electric power of the secondary battery 31 when a voltage of the secondary battery 31 assumes a second specific value or above, so that the sensors and others can be stably driven by the electric power stored in the secondary battery 31.

In the above-described embodiment, a case in which the membrane filtration device 50 is provided with the secondary battery 31 has been described. However, the membrane filtration device in the present invention may not be provided with a secondary battery. Hereafter, a case in which the membrane filtration device is not provided with a secondary battery will be described. Here, the membrane filtration device having a construction that is not provided with the secondary battery described in the following is similar to the membrane filtration device 50 described above except that the secondary battery is not provided and except for the switching process executed in the membrane filtration device, so that the description other than the switching process executed in the membrane filtration device will be omitted. Also, common constituent elements will be described by denoting with the same reference signs.

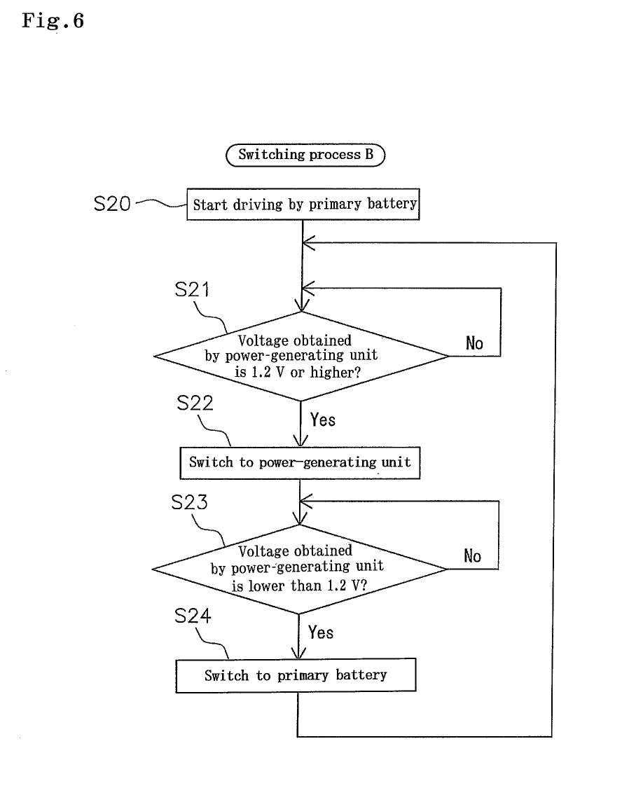

FIG. 6 is a flowchart showing a switching process B that is executed in a membrane filtration device according to another embodiment. First, when the power source is turned on in the membrane filtration device 50, the various sensors, the communication unit 36, and others are driven by the electric power of the primary battery 51 (step S20).

Next, the switching circuit 52 determines whether the voltage obtained by the power-generating unit 26 is above or equal to 1.2 V (above or equal to the first specific value) or not (step S21). When it is determined in the step S21 that the voltage obtained by the power-generating unit 26 is not above or equal to 1.2 V, the process is returned to the step S21. On the other hand, when it is determined that the voltage obtained by the power-generating unit 26 is above or equal to 1.2 V, the switching circuit 52 switches the driving of the various sensors, the communication unit 36, and others with the electric power of the primary battery 51 to driving with the electric power obtained by the power-generating unit 26 (step S22).

After the process of the step S22, the switching circuit 52 determines whether the voltage obtained by the power-generating unit 26 is less than 1.2 V or not (step S23). When it is determined in the step S23 that the voltage obtained by the power-generating unit 26 is not less than 1.2 V, the process is returned to the step S23. On the other hand, when it is determined that the voltage obtained by the power-generating unit 26 is less than 1.2 V, the switching circuit 52 switches the driving of the various sensors, the communication unit 36, and others with the electric power of the power-generating unit 26 to driving with the electric power of the primary battery 51 (step S24). Thereafter, the process is returned to the step S21.

In this manner, with the membrane filtration device 50 according to another embodiment, the driving of the sensors and others with the electric power of the primary battery 51 is switched to driving with the electric power obtained by the power-generating unit 26 when the electric power obtained by the power-generating unit 26 assumes a first specific value or above. Therefore, at the time of continuous operation when an amount of electric power supplied by the self power generation is sufficient, the sensors and others can be driven using the electric power supplied by the self power generation instead of the primary battery 51, so that the amount of electric power consumption of the primary battery 51 can be reduced.

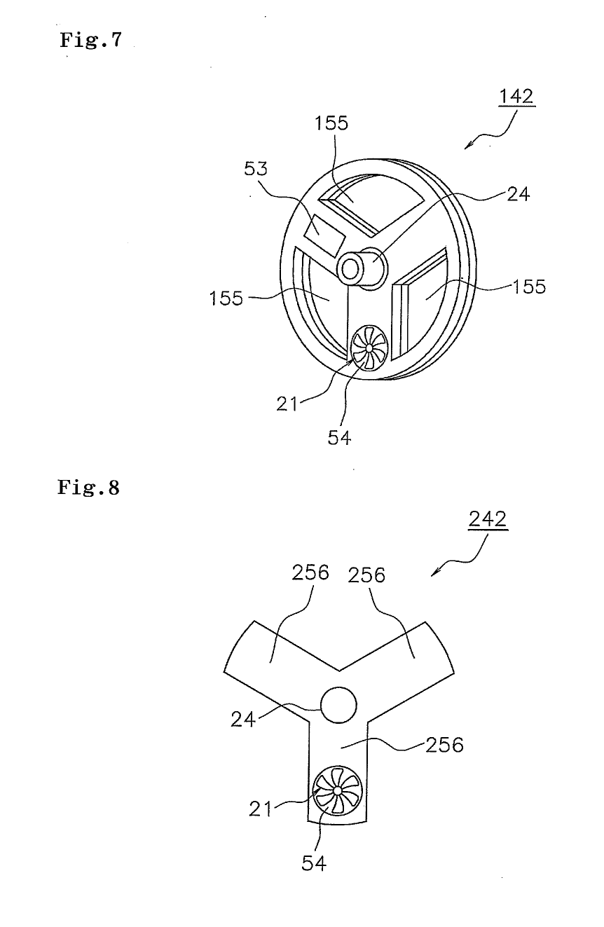

With respect to the element connection member 42 described using FIGS. 3A and 3B, a case has been described in which two openings 55 having a crescent shape are provided. However, the shape and the number of openings for passing the concentrated water that are provided besides the opening 54 (opening where the rotary body is disposed) are not particularly limited. Hereafter, other embodiments of the element connection member will be described using FIGS. 7 and 8. Here, in the following description, the same constituent elements as in the element connection member 42 will be denoted with the same reference signs, and the description thereof will be omitted.

FIG. 7 is a schematic perspective view illustrating a construction of an element connection member according to another embodiment. Referring to FIG. 7, in the element connection member 142, three openings 155 having a fan shape are provided to surround the water-passing pipe 24 besides the opening 54.

FIG. 8 is a front view illustrating a construction of an element connection member according to another embodiment. Referring to FIG. 8, the element connection member 242 has a water-passing pipe 24 and three rod members 256 that extend radially from the water-passing pipe 24 towards the outside. An opening 54 and a blade wheel 21 are provided in one of the rod members 256. In this manner, in the present invention, the element connection member need not have a circular frame on the outer circumference as in the element connection members 42, 142.

In the above-described embodiment, a case has been described in which the first specific value and the second specific value of the present invention are 1.2 V. However, the first specific value and the second specific value in the present invention are not limited to this example, and may be suitably set in accordance with the electric power needed for driving the sensors or the construction of the membrane filtration device, for example.

In the above-described embodiment, a case has been described in which the source of supplying the electric power is switched by the switching circuit 52. However, in the present invention, the switching stages including the switching stage (b) and the switching stage (c) are not limited to stages of switching by a switching circuit, so that it is possible to adopt a construction in which the switching is carried out, for example, by a control carried out by a controlling device provided with a CPU and others.

In the above-described embodiment, a case has been described in which the membrane element of the present invention is an RO element. However, the membrane element in the present invention is not limited to this example, so that it may be a precision filtration membrane (MF membrane) element, an ultrafiltration membrane (UF membrane) element, a nano filtration membrane (NF membrane) element, or the like in accordance with an object to be filtered.

In the above-described embodiment, a case has been described in which the power-generating unit of the present invention is adapted to rotate the rotary body with the fluid so as to generate electric power by electromagnetic induction. However, the power-generating unit of the present invention is not limited to this example, so that it is possible to adopt a construction in which the rotary body is rotated by the fluid so as to generate electric power by the dynamic power thereof, a construction in which the electric power is generated by the piezoelectric effect of a piezoelectric element, a construction in which an inside of a transparent pressure-resistant container capable of transmitting light is adopted to generate electric power by solar light, or the like.

### EXAMPLES

### Example 1

A substrate constructed with a resin molded body that can be mounted between membrane elements was prepared. On this substrate, two unit-4 battery alkaline batteries (primary batteries) connected in series, an electrode for measuring the electric conductivity of permeated water, a piezoelectric element for sensing the pressure of raw water (concentrated water), a ZigBee chip for wireless communication, a microcomputer that performs power source management and control of each sensor, an A-D converter that converts an analog signal from each sensor to a digital signal, and a quartz oscillator serving as a timing device were mounted. Further, a turbine-type power-generating element capable of supplying electric power of 0.5 mWh or more in an environment of a water stream supplied at a water pressure of 5.5 MPa was connected. The substrate on which the above electric components had been mounted was sealed around the whole perimeter thereof with an epoxy resin, thereby to impart a water pressure resistance to the above electric components. Next, the substrate sealed around the whole perimeter thereof and the turbine-type power-generating element were mounted on an element connection member as described using FIGS. 3A to 3C. The element connection members and the membrane elements were connected, and this was placed in a pressure-resistant container. Sea water was supplied to this pressure-resistant container at a pressure of 5.5 MPa, so as to perform a water-producing process. The water-producing process was carried out for 30 days. However, among the 30 days, stoppage for one hour was carried out for one time. The measurement of electric conductivity was carried out once for every one hour until 10 hours passed after the start of operation. Thereafter, the measurement was carried out once for every 24 hours. Here, the period of time needed for one time of the electric conductivity measurement was 10 seconds. Here, in performing the measurements using this substrate, an electric power of at least 0.5 mWh is required. As a result of this, the measured values assumed stable values for 30 days including the time of initial measurements before the start of operation and during the stoppage of operation.

### Example 2

A water-producing process was carried out in the same manner as in the Example 1 except that the turbine-type power-generating element was changed to one capable of supplying electric power of 0.09 mWh and a large-capacitance electric double-layer capacitor of 1.53 F was connected to this as an electricity storage element.

As a result of this, the measured values assumed stable values for 30 days including the time of initial measurements before the start of operation and during the stoppage of operation in the same manner as in the Example 1.

### DESCRIPTION OF REFERENCE SIGNS

10 Spiral-type membrane element
12 Separation membrane
20 Core tube
21 Blade wheel
24 Water-passing pipe
25 Coil
26 Power-generating unit
30 AC/DC converter
31 Secondary battery
32 Flow rate sensor
33 Electric conductivity sensor
34 Temperature sensor
35 Contamination detection sensor
36 Communication unit
37 RFID tag
38 Communication device
39 Pressure sensor
40 Pressure-resistant container
42, 142, 242 Element connection member
50 Membrane filtration device
51 Primary battery
52 Switching circuit
53 Substrate
54 Opening

1. A membrane filtration device provided with a membrane element that produces a permeate by filtering an object to be filtered with a filtration membrane, comprising:
a pressure-resistant container that contains said membrane element;
a sensor that senses the properties of the liquid flowing through said membrane filtration device;
a power-generating unit that generates electric power; and
a primary battery,
wherein said sensor, said power-generating unit, and said primary battery are provided in the inside of said pressure-resistant container.

2. The membrane filtration device according to claim 1, including a mounting member that can be attached to and detached from said membrane element, wherein said sensor, said power-generating unit, and said primary battery are provided on said mounting member.

3. The membrane filtration device according to claim 1, wherein a secondary battery that stores the electric power obtained in said power generating unit is provided in said pressure-resistant container.

4. The membrane filtration device according to claim 1, wherein said power-generating unit includes a rotary body that rotates by a fluid pressure of the liquid flowing within said membrane filtration device, and electric power is generated on the basis of the rotation of said rotary body.

5. A method of operating the membrane filtration device according to claim 1, comprising:
a stage (a) of driving the sensor with an electric power of the primary battery; and
a stage (b) of switching the driving of said sensor with the electric power of said primary battery to driving with the electric power obtained by said power-generating unit when the electric power obtained by the power-generating unit assumes a first specific value or above.

6. A method of operating the membrane filtration device according to claim 3, comprising:
a stage (a) of driving the sensor with an electric power of the primary battery; and
a stage (c) of switching the driving of said sensor with the electric power of said primary battery to driving with the electric power of said secondary battery when a voltage of said secondary battery assumes a second specific value or above.

7. The membrane filtration device according to claim 2, wherein a secondary battery that stores the electric power obtained in said power generating unit is provided in said pressure-resistant container.

8. The membrane filtration device according to claim 2, wherein said power-generating unit includes a rotary body that rotates by a fluid pressure of the liquid flowing within said membrane filtration device, and electric power is generated on the basis of the rotation of said rotary body.

9. A method of operating the membrane filtration device according to claim 7, comprising:
a stage (a) of driving the sensor with an electric power of the primary battery; and
a stage (c) of switching the driving of said sensor with the electric power of said primary battery to driving with the electric power of said secondary battery when a voltage of said secondary battery assumes a second specific value or above.
